(19) United States
(12) Patent Application Publication
(10) Pub. No.: US 2012/0196741 A1
(43) Pub. Date: Aug. 2, 2012

(54) Thin Film Ink Catalyst

(75) Inventor: Alireza Pezhman Shirvanian, Ann Arbor, MI (US)

(73) Assignee: FORD GLOBAL TECHNOLOGIES, LLC, Dearborn, MI (US)

(21) Appl. No.: 13/351,713

(22) Filed: Jan. 17, 2012

Related U.S. Application Data
(60) Provisional application No. 61/437,315, filed on Jan. 28, 2011.

(51) Int. Cl. B01J 35/02; B01J 23/38

(52) U.S. Cl. 502/159; 502/300

(57) ABSTRACT

In one embodiment, a catalyst ink includes a number of catalytic particles each including a particle base which supports a 2-dimension (2D) extensive catalyst film, the 2D extensive catalyst film including at least one precious metal. The 2D extensive catalyst film may contact an exterior surface of the particle base. The 2D extensive catalyst film may contact an interior surface of the particle base. In another embodiment, the particle base has a base dimension that is 50 to 10,000 times greater than a thickness of the 2D extensive catalyst film. In certain instances, the particle base has a base dimension that is 100 to 5,000 times greater than a thickness of the 2D extensive catalyst film.

### CROSS-REFERENCE TO RELATED APPLICATION

This application claims the benefit of U.S. provisional application Ser. No. 61/437,315 filed Jan. 28, 2011, the entire contents thereof are incorporated herein by reference.

### TECHNICAL FIELD

The present invention relates to a thin film ink catalyst.

### BACKGROUND

While reliability and working lifetime have been considered for utilizing fuel cell (FC) technologies in automotive applications, catalyst activity remains one factor that needs thorough consideration for commercializing fuel cell technologies and in particular fuel cell vehicles. Efforts have been made with a focus on developing fuel cell catalysts having a desirable electro-catalytic oxygen reduction reaction (ORR). To this end, fuel cell catalysts show some improvement over pure platinum nano-particles and/or pure platinum alloys nano-particles supported on carbon. However, these conventional catalysts, by virtue of being nano-particles, are still prone to agglomeration, dissolution and other durability issues. Development of a durable and active catalyst for proton exchange membrane fuel cell (PEMFC) applications remains a challenge.

### SUMMARY

In one embodiment, a catalyst ink includes a number of catalytic particles each including a particle base which supports a 2-dimension (2D) extensive catalyst film, the 2D extensive catalyst film including at least one precious metal. The 2D extensive catalyst film may contact an exterior surface of the particle base. The 2D extensive catalyst film may contact an interior surface of the particle base.

In another embodiment, the particle base has a base dimension that is 50 to 10,000 times greater than a thickness of the 2D extensive catalyst film. In certain instances, the particle base has a base dimension that is 100 to 5,000 times greater than a thickness of the 2D extensive catalyst film.

In yet another embodiment, the 2D extensive catalyst film has a thickness of 1 to 20 atomic layers.

In yet another embodiment, the catalyst ink further includes, for at least a portion of the particles, a first intermediate coating disposed between the particle base and the 2D extensive catalyst film. In certain instances, the catalyst ink further includes a second intermediate coating disposed between the particle base and the 2D extensive catalyst film. In certain other instances, the first intermediate coating is compositionally different from the second intermediate coating.

In yet another embodiment, the catalyst ink further includes an ink filler.

### BRIEF DESCRIPTION OF THE DRAWINGS

FIG. 1A depicts a catalyst ink according to one or more embodiments of the present invention;

FIG. 1B1 depicts an enlarged cross-sectional view of a catalyst particle referenced in FIG. 1A;

FIG. 1B2 depicts another enlarged cross-sectional view of the catalyst particle referenced in FIG. 1B1;

FIG. 1C depicts another enlarged cross-sectional view of the catalyst particle referenced in FIG. 1B1;

FIG. 2A depicts an enlarged sectional view of a variation to the catalyst ink referenced in FIG. 1A;

FIG. 2B depicts an enlarged sectional view of the catalyst ink referenced in FIG. 2A;

FIG. 3 depicts a variation of the catalyst ink of FIG. 1A;

FIG. 4A depicts sample base particles according to one or more of the Examples described herein;

FIG. 4B depicts an enlarged view of platinum coated base particles referenced in FIG. 3A;

FIG. 5 depicts cyclic voltammogram of a cell based on ink made from platinum coated particles as seen in FIG. 4B compared to Pt polycrystalline disk employed in one or more of the Examples described herein;

FIG. 6 depicts polarization curve of the cell equipped with a Pt coated glass bead cathode according to one or more of the Examples described herein; and

FIG. 7 depicts XRD patterns of coated and uncoated base particles according to one or more of the Examples described herein.

FIGS. 8A to 8C depict exemplary steps for forming wires referenced in one or more embodiments of the present invention;

FIGS. 9A to 9D depict exemplary steps for forming wires referenced in FIGS. 8A to 8C; and

FIGS. 10A and 10B depict prior art catalyst nanoparticles.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Fuel cells have been pursued as a source of power for transportation because of their high energy efficiency and their potential for fuel flexibility. However, broad commercialization of the fuel cells has been met with many limitations, particularly in relation to the relatively high cost of the fuel cell catalyst. Some of catalyst metals as used in fuel cell applications include noble and transition metals, such as platinum, which are very expensive. One source of the high cost of conventional fuel cell catalyst may be due to the insufficient use of the catalyst itself. By way of example, conventional fuel cells employ catalyst such as Pt in the form of nano-particles supported on carbon support. The nano-particles are intrinsically less active than their bulk counterparts. Conventional platinum nano-particles are formed of several hundred or more atoms and atomic layers of Pt metals; however, only a few surface atomic layers of the nano-particles are accessible to fuel cell reactants and remain active for electrochemical reaction, while majority of the catalyst layers particles at the center of the nano-particle remain essentially inactive. In addition, due to their inherently high surface energy, nano-particles tend to aggregate to form larger particles, and may actually dissolve into the electrolyte membrane and consequently lose surface area and catalytic activities.

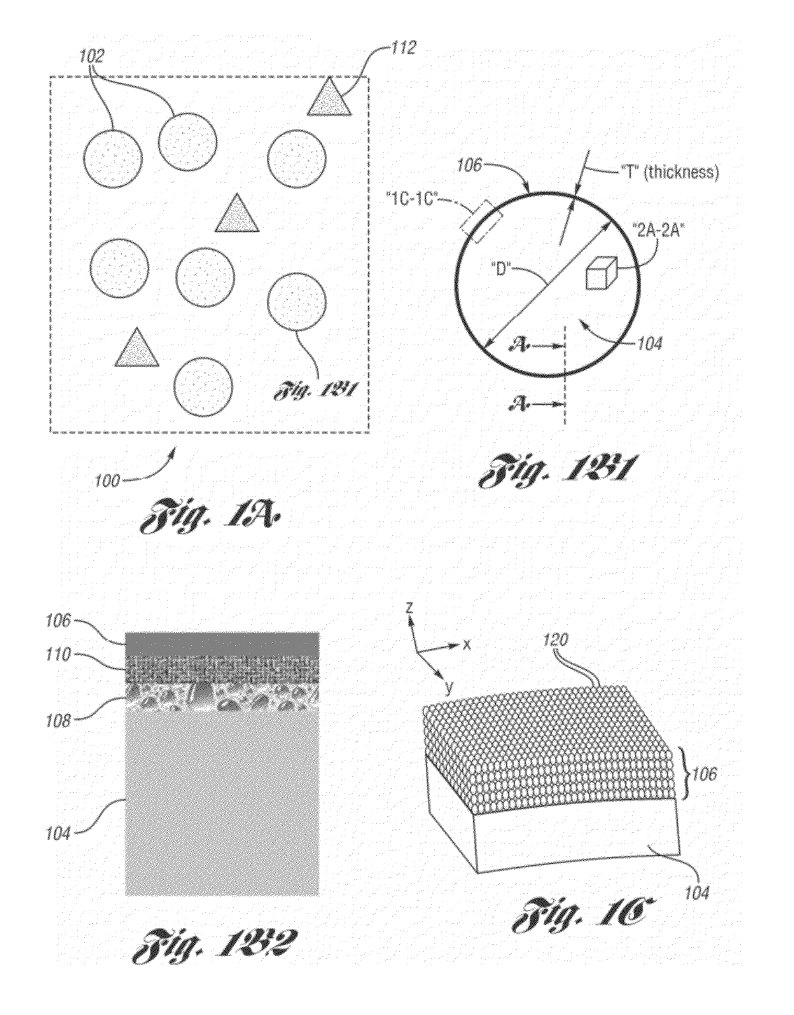

In one embodiment, and as depicted in FIG. 1A and FIGS. 1B1 to 1B2, a catalytic ink generally shown at 100 includes a number of particles 102 each including a particle base 104 and a two-dimension (2D) extensive catalyst film 106 supported on the particle base 104.

FIG. 1C illustratively depicts a cut-out “1C-1C” of FIG. 1B1. As depicted in FIG. 1C, the 2D extensive catalyst 106 is presented in a pseudo-bulk configuration such that the catalytic metals 120 behave, relative to conventional nano-particles, more like bulk metals. In this pseudo-bulk configuration, the 2D extensive catalyst 106 is presented as being first dimension such as the x-axis and second dimension such as the y-axis more extensive relative to a third dimension such as the z-axis. In certain instances, the first and second dimensions such as the x and y dimension can be no less than 25 nanometers, 50 nanometers, 75 nanometers, or 100 nanometers. In certain instances, the thickness dimension along the z-axis may be in a range of 2 to 120 atomic layers, 2 to 100 atomic layers, 2 to 80 atomic layers, 2 to 60 atomic layers, 2 to 40 atomic layers, 2 to 20 atomic layers. Without wanting to be limited to any particular theory, it is believed that the 2D extensive catalyst 102 of the catalyst assembly 100 is crystallographically oriented such that the catalytic activities of the 2D extensive catalyst 102 may be effectively utilized. The 2D extensive catalyst film 106 includes one or more catalyst crystal planes illustratively shown as layers of catalyst atoms 120 arranged in the x-y dimensions.

In certain particular instances, the continuum thin film of catalyst is provided with a continuum dimension greater than 20 nanometers along a longitudinal axis of at least one of the first and second spaced apart strands. By way of example, the continuum dimension can be an x-axis or a y-axis of a planar surface of the fuel cell catalyst layer, as opposed to a thickness axis such as a z-axis that is substantially perpendicular to the planar surface of the fuel cell catalyst layer.

The 2D extensive catalyst film 106 may include catalyst metals configured as single crystalline, polycrystalline, or combinations thereof. In the event that the single crystals of platinum are used, the single crystals of preference are characterized as having (110) and/or (111) facets. In certain particular instances, the single crystals are each provided in the thickness direction with 1 to 20 atomic layers and particularly 1 to 12 atomic layers, such that precious catalyst metals can be effectively used. Alternatively, in the event that the polycrystalline form of materials are used, the preferred polycrystalline for platinum or platinum containing alloys is characterized as having (111) facets and (100) tops. The performance of the (100), (111) and (110) crystal surface of bulk catalyst metal such as platinum is far superior to conventional platinum nano-particles. Because the catalyst such as platinum can be grown in single crystals and configured as a thin continuum film on the substrate that might have nanowires, this catalyst behaves more like the bulk metal catalyst with preferred crystalline structure and is provided with relatively higher catalytic activity per a given surface atom relative to the catalyst on surface atom in a conventional nano-particle configuration.

The performance of the (100), (111) and (110) crystal surface of bulk catalyst metal such as platinum is far superior to conventional platinum nano-particles. Because the catalyst such as platinum can be grown in single crystals and configured as a thin continuum film on the particle base, this catalyst behaves more like the bulk metal catalyst with preferred crystalline structure and is provided with relatively higher catalytic activity per a given surface relative to the catalyst in conventional nano-particle configuration.

Unlike conventional Pt/C nano-particles wherein Pt metals are present in discrete particles and electronic connection between the discrete particles is provided through the carbon support material, the catalyst metal atoms as presented in a continuum film according to one or more embodiments of the present invention are substantially connected to each other electronically without the need for an intermediate connecting medium such as carbon. When included, carbon is present in an amount less than 20 percent by weight (wt %), 15 wt %, 10 wt %, 5 wt %, 1 wt %, 0.5 wt %, or 0.05 wt % of the total dry weight of the catalyst film 106.

Although being depicted in FIGS. 1A and 1B1 as enclosing the entire volume of particle base 104, 2D extensive catalyst film 106 does not necessarily have to fully enclose the entire volume of particle base 104. In suitable variations, and as depicted in FIG. 3, the 2D extensive catalyst film 106 and optionally the intermediate coating 108 and/or 110 may each independently be positioned next to, and in certain instances may be contacting, a portion of the particle base 104. The portion may be 10 to 30 percent, 30 to 50 percent, 50 to 70 percent, 70 to 90 percent, or 90 to 99 percent.

The particle base 104 may include a generally non-porous support material such as glass, and/or a generally porous support material such as porous sorbents. Non-limiting examples of the sorbents include carbon-based sorbents such as activated carbon, aerogels, and foam, and metal-based sorbents such as metal-organic frameworks (MOFs).

Non-limiting examples of the MOFs include: a catalytically-active MOF-5 having embedded metal, such as Ag@[Zn₄O(BDC)₃], Pt@[Zn₄O(BDC)₃], Cu@[Zn₄O(BDC)₃], and Pd@[Zn₄O(BDC)₃]; an organically solvated MOF, such as Ti(OⁱPr)₄[Cd₃Cl₆(LI)₃.4DMF.6MeOH.3H₂O, Ti(OⁱPr)₄[Cd₃(NO₃)₆(LI)₄.7MeOH.5H₂O, Ti(OⁱPr)₄[Cd(LI)₂(H₂O)₂][ClO₄]₂.DMF.4MeOH.3H₂O, [Rh₂(M²⁺TCPP)₂], where M²⁺ may include Cu, Ni, or Pd, and [Zn₂(BPDC)₂(L2)].10DMF.8H₂O; an ionically or partially ionically solvated MOF, such as [Ni(L-aspartate)bpy_{0.5}]HCl_{0.9}MeOH_{0.5}, [Cu(L-aspartate)bpy_{0.5}]HCl, [Cu(D-aspartate)bpy_{0.5}]HCl, [Cu(D-aspartate)bpy_{0.5}]HCl, Cr₃(F,OH)(en)₂O(BDC)₃(ED-MIL-101), [Zn₃O(L3-H)].(H₃O)₂(H₂O)₁₂(D-POST-1), [Sm(L4-H₂)(L4-H₃)(H₂O)₄].(H₂O)ₓ, [Cu(bpy)(H₂O)₂(BF₄)(bpy)], [Zn₄O(BDC)₃](MOF-5), [Ln(OH)H₂O)(naphthalenedisulfonate)] where Ln includes a lanthanide metal such as Nd, Pr, or La; as well as [In₄(OH)₆(BDC)₃], [Cu₃(BTC)₂], [Sc₂(BDC)₃], [Sc₂(BDC)_{2.5}(OH)], [Y₂(BDC)₃(H₂O)₂].H₂O, [La₂(BDC)₃(H₂O)₂].H₂O, [Pd(2-pymo)₂], [Rh₂(H2TCPP)₂)BF₄, [Cu₂(trans-1,4 cyclohexanedicarboxy-late)₂]H₂O, [Cu(2-pymo)₂], [Co(PhIM)₂], [In₂(BDC)₃(bpy)₂], [In₂(BDC)₂(OH)₂(phen)₂], [In(BTC)(H₂O)(bpy)], [In(BTC)(H₂O)(phen)], [Sc₂(BDC)_{2.5}(OH)], [Y₂(BDC)₃(H₂O)₂].H₂O, [La₂(BDC)₃(H₂O)₂]H₂O, [Cu₃(BTC)₂], [Cd(4,4′-bpy)₂(H₂O)₂]-(NO₃)₂.(H₂O)₄, [Sm(L4-H₂)(L4-H₃)(H₂O)₄].(H₂O)ₓ, Mn₃[(Mn₄Cl)(BTT)₈(MeOH)₁₀]₂, [Zn₄O(BDC)₃](MOF-5), Ti-(2,7-dihydroxynaphthalene)-MOF, [Pd(2-pymo)₂], [Cu₃(BTC)₂], [Rh₂(L5)], [Rh(BDC)], [Rh(fumarate)], [Ru(1,4-diisocyanobenzene)₂]Cl₂, [Ru₂(BDC)₂], [Ru₂(BPDC)₂], [Ru₂(BDC)₂(dabco)], [Ru₂(BPDC)₂(dabco)], [Rh₂(fumarate)₂], [Rh₂(BDC)₂], [Rh₂(H₂TCPP)₂], and [Pd(2-pymo)₂].

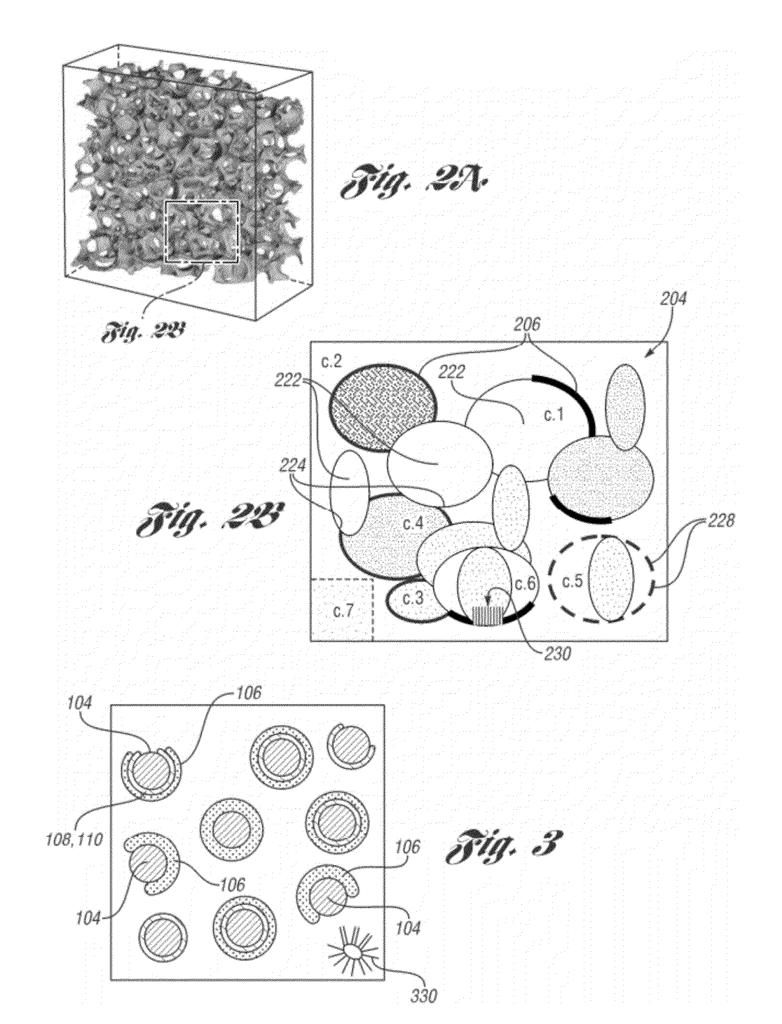

When the particle base 104 is relatively porous, the 2D extensive catalyst film 106 may be in contact with an interior surface of the particle base 104. Pore surface 224 referenced in FIG. 2B is a non-limiting example of such an interior surface. In this connection, the catalyst materials may be deposited onto the interior surface via any suitable methods to form the 2D extensive catalyst film 106. In this connection also, certain portions of the 2D extensive catalyst film 106 may be discontinuous or separate from each other to accommodate its contact with both the exterior and interior surfaces.

In a variation, and as depicted in FIG. 2A and FIG. 2B, an enlarged view of a cut-out section “2A-2A” referenced in FIG. 1B1 contains 2D extensive catalyst film 206 contacting portions of pore surface 224 of the particle base 204. The form and extent of contact between the pore surface 224 and the 2D extensive catalyst film 206 may vary. For instance, as shown in region C.1 of FIG. 2B, the 2D extensive catalyst film 206 contacts a portion the pore surface 224; as shown in region C.2 of FIG. 2B, the 2D extensive catalyst layer 206 may cover the entire pore surface 224 and the pore 222 may contain one or more ionomers and/or porous carbon to assist with proton and gas transport and water management; as shown in region C.3, the pore 222 contacts 2D catalyst film 206 and contains one or more ionomers. As shown in region C.4, the pore 222 contains the 2D catalyst film 206 and is filled with water and ionomers. As shown in region C.5, the pore surface 224 contacts two or more spaced apart patches 228 of the 2D extensive catalyst film 206. As depicted in region C.6 shown in FIG. 2B, the particle base 204 further includes a plurality of wires 230 extending longitudinally from the pore surface 224 and at least a portion of the wires 230 may be in contact with the 2D extensive catalyst film 206. As shown in region C.7, secondary pores may be provided, independently or in addition to the pores 222, to assist with reactant transport and water management. In certain instances, the secondary pores can be natural pores integral to the particle base 204, wherein the pores 222 can be later formed in and around the particle base catalyst film 206 and 204 that already has the secondary pores show in region C.7.

Although being depicted in FIGS. 1A and 1B1 as having a sphere shape in general, the particle base can be of any suitable shape. Non-limiting examples of the particle base 104 include sphere, column, cone, any other regular or irregular shapes.

The particle base 104 may be formed of any suitable support materials. In certain instances, the particle base 104 includes one or more non-precious metals, including cobalt (Co), nickel (Ni), iron (Fe), titanium (Ti), vanadium (V), chromium (Cr), and alloys and combinations thereof. Precious metals may also be included in the particle base 104; however, this would not serve any particularly economical purposes as many of the precious metals included in the particle base 104 will not be readily accessible to the catalyst reactions. This inaccessibility worsens as deeper the precious metals are located within the particle base 104.

In a variation, some of the catalyst particles 102 may contain one or more nanostructures such as nanowires. The term “wires” and “nanowires” may be used interchangeably. The term “nanowire” does not necessarily indicate that the wires are of dimensions in nanometer scale. The wires or the nanowires may have an average diameter in nanometer scale and/or an average length in micrometer scale. The term “wires” may refer to any nano-structures of any suitable shape to provide added surface area. In certain other instances, the term “wires” does not necessarily indicate that the wires 330 are of dimensions in nanometer scale. The wires 330 may have an average diameter in nanometer scale and/or an average length in micrometer scale. In yet certain other instances, the term “wires” may refer to nano-structures floating within the ionomer mixture contained in the pores and not necessarily contacting or attaching to any pore surface.

As depicted in FIG. 1B1, the particle base 104 has a base dimension that is 50 to 10,000 times greater than a thickness “T” of the 2D extensive catalyst film 106. The base dimension may be defined as a line dimension connecting two points on an outer surface of the particle base 104. In certain particular instances, a ratio between the base dimension of the particle base 104 relative to the thickness of the 2C extensive catalyst film 106 is no less than 75, 100, 125, 150 or 175, and no greater than 7,500, 5,500, 3,500, or 1,500.

The 2D extensive catalyst film may have a thickness of 1 to 500, 1 to 250, 1 to 100, 1 to 50 or 1 to 20 atomic layers.

The 2D extensive catalyst film 106 may include any suitable catalyst materials and in some instances, may include one or more precious metals and alloys thereof. Non-limiting examples of the precious metals include ruthenium (Ru), rhodium (Rh), palladium (Pd), silver (Ag), osmium (Os), iridium (Ir), platinum (Pt), gold (Au), and alloys and combinations thereof.

In certain instances, and as depicted in FIG. 1B2, one or more of the particles 102 may further include a first intermediate coating 108 disposed between the particle base 104 and the 2D extensive catalyst film 106. In certain other instances, one or more of the particles 102 may further include a second intermediate coating 110 disposed between the particle base 104 and the 2D extensive catalyst film 106. The intermediate coatings 108, 110 may have one or more of the following functions: to protect the core material/other coatings in FC environment; to induce better catalytic activity thru lattice mismatch/electronic interactions with catalyst/other pre-coatings; and to promote growth of certain desirable crystalline orientations/nanostructures. Examples for these pre-coatings may include polymers/(conductive or non-conductive), metal oxides (such as NbO₂, Nb₂O₅, WO₃, NaₓWO₃, and WC), and/or metals (such as Ir, W, Os, Rh, Ru, Mo, Nb, Ta, V).

For instance, niobium oxide and iridium may be employed to interact with catalyst support to produce: a) high surface area support; b) more active catalysts—through electronic structure and lattice mismatch interactions between support and catalyst or through promotion of the growth of favorable crystalline facets of the catalyst due to interaction between catalyst and support—many polymers either conductive or non-conductive could produce such effects; c) using higher surface energy support metal/metal oxide materials, one can generate a more conformal coating of catalyst on the support as opposed to nucleating the catalyst on the support—conformal coating of the catalyst on support leads to a true thin film with minimal and uniform thickness thereby reducing the requisite catalyst loading.

Ink filler 112 may include materials that enhance electrical conductivity including porous carbon, metals, and/or metal oxides; materials that enhance gas and reactant transport including porous materials such as porous carbon; materials that promote proton conductivity including ionomer; materials that assist with water management within the catalyst layer including Teflon, synthetic and non-synthetic fibers; and/or materials that increase structural stability and adjust mechanical properties of the catalyst layer including fibers of carbon or different materials. Although being depicted as separate entities, ink filler 112 may be materials that tend to fill open spaces between the catalyst particles 102 to provide electronic, protonic and gas conductivity.

Useful electrolytes included in the ink filler 112 may include copolymers of tetrafluoroethylene and one or more fluorinated, acid-functional comonomers. Typical polymer electrolytes include Nafion® (DuPont Chemicals, Wilmington Del.) and Flemion™ (Asahi Glass Co. Ltd., Tokyo, Japan). While Nafion® is a common PEM, the usefulness of this invention is not limited by a particular choice of Nafion or any other solid electrolyte. In fact, liquid electrolytes and solid electrolytes are both amenable.

Suitable deposition methods may include chemical vapor deposition, physical vapor or thermal deposition, ion sputtering, and ion beam assisted deposition (IBAD). Vacuum deposition techniques, preferably electron beam physical vapor deposition (EB-PVD) or RF sputtering, may be used to deposit the catalyst metals onto a support such as particle base 104. Any suitable stamping techniques for micro or nano-fabrication applications can be used to manufacture the particle base 104.

The following is a non-limiting list of factors that may be considered in designing the particle base. The particle base may be sized to collectively provide sufficient surface area for catalytic reactions. The particle base may be chemically resistive to corrosive electrochemical environment in the fuel cells. In certain instances, the particle base is enclosed within the thin film catalyst coating to avoid exposure of the particle base to the corrosive environment. In certain other instances, the coating base may include one or more pre-coating materials to protect against the electrochemically corrosive environment, to increase adhesion and stability of later deposited catalyst, and/or to increase activity and promote growth of certain crystalline orientation of the later coated catalyst through electronic interactions and lattice mismatch. In yet certain other instances, the coating base may contain additional surface nanostructures or internal voids or porosity to enhance catalytic surface area.

In one or more embodiments, the thin film supported on the particle base may be extended in x and y directions while being only a few atomic layers thick in the z direction. The size (x and y) of such a patch of thin film that also provides superior bulk like activity (pseudo-bulk) may, in certain instance, be greater than 30 nm. Micron sized particles that are covered with thin film patches of 30 nm or larger of catalyst could be acceptable sizes for TFIC. The requirement for the size of the thin film may set some limit on the size of the objects to be coated for inclusion in TFIC. For instance, the minimum glass particle size to be coated for use as in TFIC may, in certain instances, be 30 nm. Also the thin film of catalyst could cover the entire surface or interior of the catalytic particle (if porous) without forming patches of discrete catalytic spots of the aforementioned size. In certain other instances, it may be desirable to stick with larger particles to minimize the high surface energy areas associated with high curvature in smaller particles. On the other hand, the particles should not be too large to fail to generate the requisite surface area for catalytic reactions. These two factors, in addition to other factors partially described in Examples 1-2 help determine the sizes of the catalytic objects.

One or more of the following advantages may be realized according to one or more embodiments of the present invention. 1) Significant reduction in dissolution of catalyst may be realized. Degradation due to particle dissolution may be removed since TFIC surface is intrinsically more stable than platinum nano-particles due to the lower surface energy associated with films. 2) Significant reduction in agglomeration of catalyst may be realized. Degradation due to particle agglomeration may be removed. The catalyst layer based on catalyst thin film does not contain nanoparticles and the surface properties of thin films more resemble that of the bulk metal which are far more resistive to agglomeration than nano-particles. 3) Catalyst loading may be reduced significantly. In conventional catalysts with nanoparticles on carbon support, only the very first few atomic layers of Pt-alloy remains active for electrochemical reaction, while the rest of the catalyst metal at the center of the nanoparticle remains essentially inactive. By utilizing TFIC, one can control and optimize the number of atomic layers deposited on the substrate, therefore save significantly on precious metal loading.

One or more of the following additional advantages may be realized according to one or more embodiments of the present invention. 1) The catalyst atoms present in the catalyst film 106 potentially have a 9-fold increase in catalytic activity over the standard Pt/C particles. The thin film in the catalyst film 106 maybe grown to expose single crystalline features of catalyst and thereby increase catalytic activity several times over. This feature is not possible with conventional Pt/C particles. 2) The catalyst film 106 can be used to implement the breakthrough electro-catalyst alloy Pt3Ni with “Pt-Skin” and “Core-Shell” catalysts in fuel cells. This alloy is shown by Stamenkovic et al. to be 90 times more active than Pt/C (almost two orders of magnitude). As mentioned in these Refs., the main challenge in utilizing Pt3Ni catalyst in fuel cells will be creating a nano-catalyst with electronic and morphological properties similar to Pt3Ni (111). Given that thin films 106 can be grown into well-defined crystalline surfaces, the incorporation of Pt3Ni (111) to fuel cells can become a reality. 3) The infrastructure for disposing ink in fuel cell MEAs already exist. Due to the ink based nature of this catalyst 102, it is anticipated that the existing tooling at MEA manufacturers could be easily adapted to produce MEAs. This advantage can bring about significant cost and time savings.

### EXAMPLES

### Example 1

Glass spherical particles with 3 micron diameter are coated with 4 atomic layers of Pt catalyst. The catalyst layer thickness is of 20 microns. The close packing limit for spheres is about 0.74, or 74%. It is noted that close packing limit for spheres in face centered cubic arrangement is 74%, and the void volume is 26%. The packing limit may vary with particle shape. To allow inclusion of other ingredients in the ink, the glass spheres make up about 34% in volume of the catalyst ink layer and the rest of the total volume is filled with other ingredients such as porous carbon and ionomer. The calculation shown in Table 1 shows a desirable surface area enhancement of 13.6 cm²/cm² yet with a much decreased Pt loading of 3.3×10⁻⁵ g/cm² or 0.033 mg/cm².

TABLE 1

| Density of glass particles | 2.4 | g/cm³ |
|---|---|---|
| Particle diameter | 3 × 10⁻⁴ | cm |
| Particle surface area | 2.8 × 10⁻⁷ | cm² |
| particle volume | 1.4 × 10⁻¹¹ | cm³ |
| Catalyst layer thickness | 2 × 10⁻³ | cm |
| Catalyst layer volume per cm² planar area | 2 × 10⁻³ | cm³/cm² |
| Packing fraction | 0.34 | |
| Volume fraction of the glass particles per cm² | 6.8 × 10⁻⁴ | cm³ |
| planar area | | |
| Number of glass particles per cm² planar area | 4.8 × 10⁷ | |
| Total surface area by the glass particles per cm² | 13.6 | cm²/cm² |
| planar area | | |
| Mass of the glass particles per cm² planar area | 1.6 × 10⁻³ | g/cm² |
| Density of platinum | 21.5 | g/cm³ |
| Number of platinum layers coated | 4 | |
| Total thickness of the 4 platinum layers coated | 11.2 | Angstrom |
| Volume of platinum per cm² planar area | 1.5 × 10⁻⁶ | cm³/cm² |
| Mass of platinum per cm² planar area | 3.3 × 10⁻⁵ | g/cm² |

### Example 2

Glass spherical particles with 1 micron diameter are coated with 4 atomic layers of Pt catalyst. The catalyst ink layer thickness is 20 micron. The close packing limit for spheres is about 0.74 or 74%. To allow inclusion of other ingredients in the ink, the glass spheres make up about 45% in volume of the catalyst ink layer and the rest of the total catalyst volume is filled with other ingredients such as porous carbon and ionomer. The calculation shown in Table 2 shows a desirable surface area enhancement of 54 cm²/cm² yet with a much reduced Pt loading of about 1.3×10⁻⁴ g/cm² or 0.13 mg/cm².

TABLE 2

| Density of glass particles | 2.4 | g/cm³ |
|---|---|---|
| Particle diameter | 1 × 10⁻⁴ | cm |
| Particle surface area | 3.1 × 10⁻⁸ | cm² |
| particle volume | 5.2 × 10⁻¹³ | cm³ |
| Layer thickness | 2 × 10⁻³ | cm |
| Layer volume per cm² planar area | 2 × 10⁻³ | cm³/cm² |
| Packing fraction | 0.45 | |
| Volume fraction of the glass particles per cm² | 9 × 10⁻⁴ | cm³ |
| planar area | | |
| Number of glass particles per cm² planar area | 1.7 × 10⁹ | |
| Total surface area by the glass particles per cm² | 54 | cm²/cm² |
| planar area | | |
| Mass of the glass particles per cm² planar area | 2.1 × 10⁻³ | g/cm² |
| Density of platinum | 21.5 | g/cm³ |
| Number of platinum layers coated | 4 | |
| Total thickness of the 4 platinum layers coated | 11.2 | Angstrom |
| Volume of platinum per cm² planar area | 6.0 × 10⁻⁶ | cm³/cm² |
| Mass of platinum per cm² planar area | 1.3 × 10⁻⁴ | g/cm² |

### Example 3

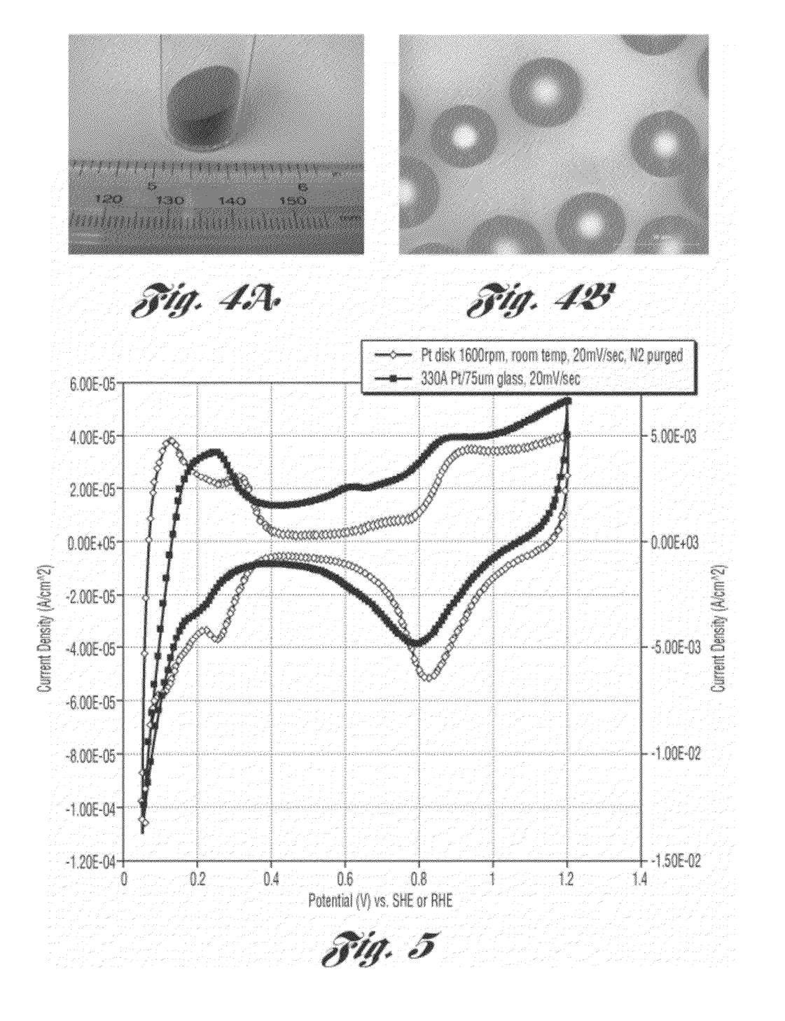

Spherical glass particles of diameter 75 micron are obtained from Sigma Aldrich. The atomic layer deposition (ALD) technique is used to deposit a Pt layer of about 33 nm on the surface of the spheres depicted in FIGS. 4A and 4B.

An example catalyst ink consists of 100 mg of Pt coated glass sphere, to which 100 mg of 20 wt % Ion Power Nafion solution is added, as well as 400 mg of 99% glycerol for a dry loading of 17 wt % Nafion. The ink is stirred in a glass vial at 180 rpm for 6-8 hours. Most of the Pt coated glass beads settle at the bottom of the vial. The dispersed beads settle if the ink solution remains unstirred overnight (the as-prepared ink is insufficiently dense to support a stable suspension of the Pt coated glass beads). The ink solution is applied with a cotton-tipped applicator to an ETEK LT2500-W GDL (353 μm) to cover the GDL surface. The coated GDL is dried for 2 hours at 80° C., and vacuum dried for 8 hours at 80° C. and −25 mm Hg to drive off remaining glycerol. ETEK LT250E GDE with a loading of 5 g/m² of Pt is used as the anode.

As-received Nafion 115 from Ion Power is washed for 2 hours in 3% H₂O₂ solution at 80° C., followed by a DI water rinse, 2 hours in 1M H₂SO₄ at 80° C., a DI water rinse, and then 2 hours in 1M Na₂SO₄ to convert the Nafion to the sodium form for pressing. The Nafion is converted back to the proton form by treatment in 1M H₂SO₄ at 80° C. for 2 hours, and vacuum dried at 80° C. for 4 hours before installation in the cell fixture. Fuel Cell Technologies 5 cm² hardware is used to support the membrane and GDEs. The cell is assembled dry at room temperature and humidity. Cell components are allowed to cool to room temperature before assembly.

FIG. 5 shows cyclic voltammogram of Pt polycrystalline disk from RDE compared to CV on fuel cell equipped with 75 micron glass particles coated with platinum. Pt disk: 0.1 M HClO₄, 1600 rpm, and 20 mV/sec at room temperature. Fuel cell case: 80° C., 100% RH, 300 sccm H₂ 170 kPag anode, 500 sccm N₂ 150 kPag cathode, 20 mV/sec. The significant double layer charging in the fuel cell case is believed to be due in part to the high interfacial resistance from the cathode catalyst layer/membrane interface. As this CV is acquired prior to any conditioning, the cathode catalyst layer probably has not been in intimate contact with the membrane. Further thermal cycling and conditioning may decrease the initially high resistance. The shoulder being centered at 0.6 V in the fuel cell CV trace is likely due to the oxidation of remaining alcohols in the catalyst layer. The current cathode catalyst layer covers approximately 30% of the cathode planar area with Pt coated glass beads. The geometric area of the cell is used for current density and other calculations where an area is required.

All ECA, hydrogen crossover, and HFR measurements are carried out at 200 sccm H₂ flow (anode)/300 sccm N₂ (cathode), 50/50 kPag, 80° C. cell (the cell is heated up to 80° C.) and 80° C. dewpoint temperatures (roughly 100% humidity). The hydrogen crossover rate at 80° C. is 0.7 mA/cm², which is acceptable for Nafion 115 (literature values for 20 μm thick Nafion are on the order of 2 mA/cm²). High frequency resistance is immeasurable in either potentiostatic or galvanostatic mode. The cell resistance at 1 kHz frequency with a 10 mV applied potential at open circuit in hydrogen/nitrogen (84 mV) is 50 Ωcm². The ECA is 42.0 cm² Pt per cm² planar, but the current density is based on a 5 cm² area, and not exclusively the area covered by Pt particles. It is significant that the thin film ink catalyst behaves very similarly in its CV values with polycrystalline bulk Pt.

FIG. 6 shows polarization curve of the cell equipped with a Pt coated glass bead cathode. 80° C. cell, 85° C. line, and 80° C. dewpoint temperatures, 100 kPag anode and cathode backpressure, and 200 sccm H₂ (anode)/500 sccm air (cathode), 5 minute points with the final 30 seconds averaged per point. The cell is flushed with room temperature water for 20 minutes to remove impurities prior to this polarization measurement. Given that only a fraction of the active area of the 5 cm² cell is covered with a monolayer of Pt coated glass beads, the performance of the cell as observed is surprisingly good.

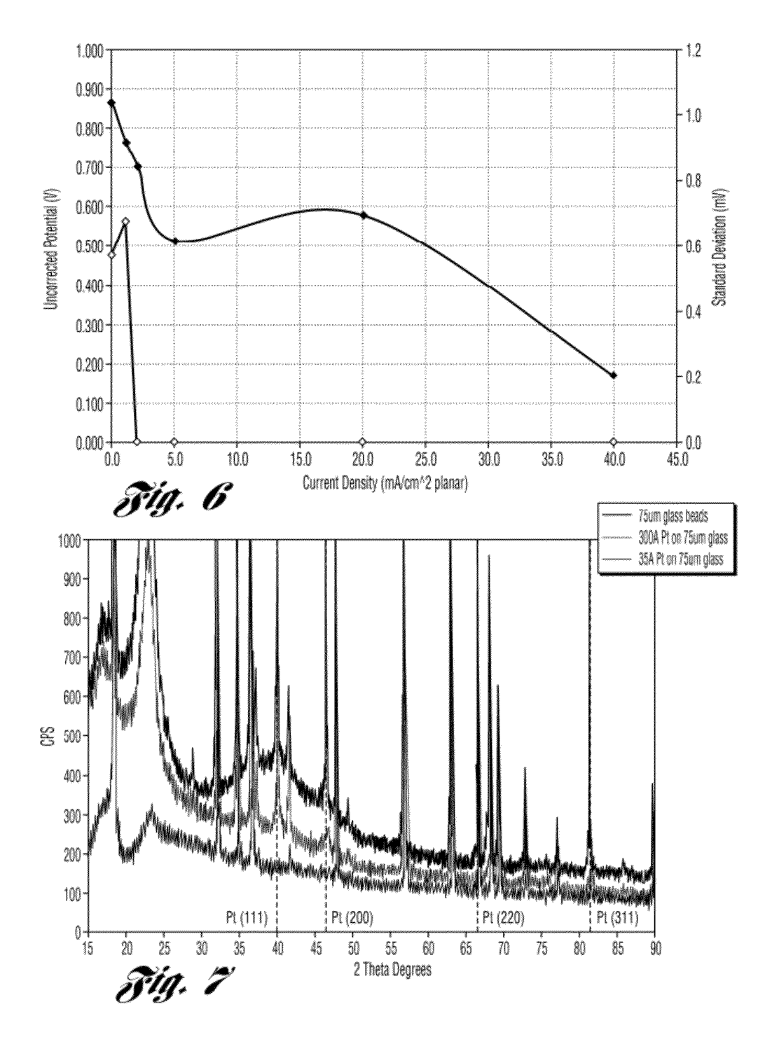

FIG. 7 shows XRD patterns of coated and uncoated glass beads mounted on double sided tape. Polycrystalline platinum is present in both coated glass bead samples.

### Example 4

### Forming the Wires 230, 330

Several methods can be used to manufacture the wires as described herein. Among them are evaporation-condensation, vapor-liquid-solid (VLS) growth, and template based. In this example, templates such as anodized alumina membrane (AAM) and radiation track-etched polycarbonate (PC) membranes are used.

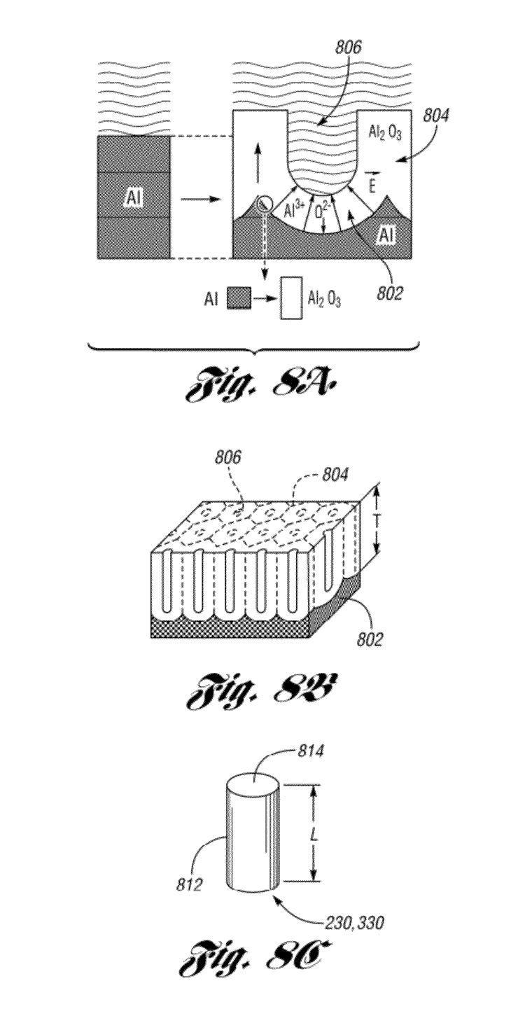

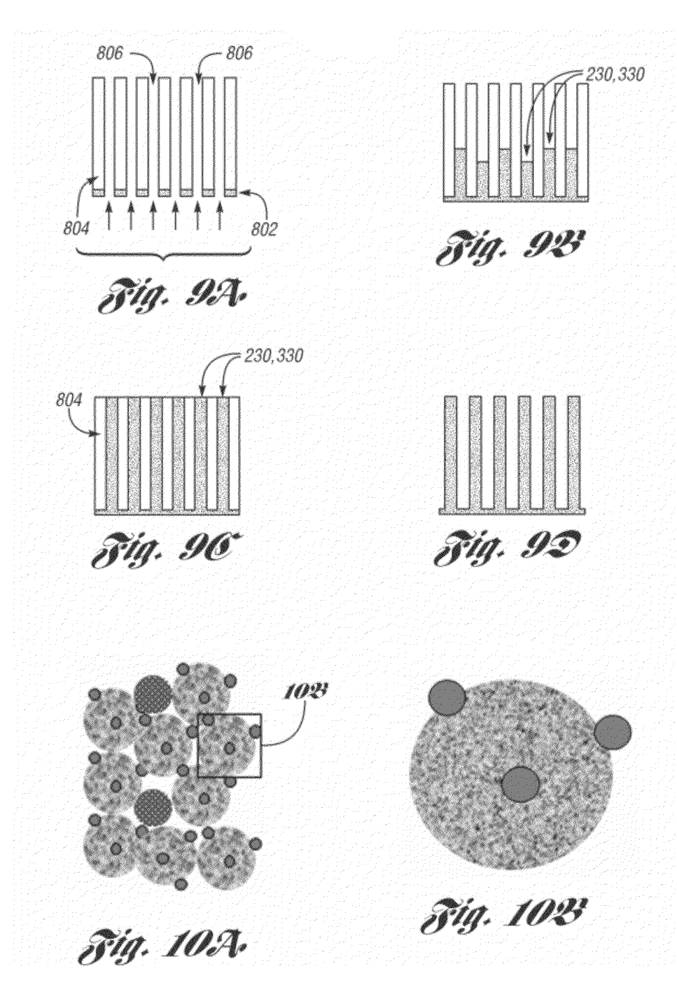

Commonly used alumina membranes having uniform and parallel pores are produced by the anodization of aluminum sheets or films in solutions of sulfuric, oxalic or phosphoric acid. As shown in FIGS. 8A to 8C and 9A to 9D, pores 806 can be arranged in a regular hexagonal array as seen in FIG. 8B, and as many as 10¹¹ pores/cm² can be obtained. Pore sizes range from 10 nm to 100 μm. After formation of the pores, the barrier oxide layer 802 at the bottom of the pores 806 is removed by dissolution in sodium hydroxide and mechanical agitation.

Membrane etching and catalyst electro-deposition follow thereafter according to FIGS. 9A-9D. As depicted in FIG. 9A, a conductive layer 802 of copper or gold is sputtered onto the bottom of the substrate 804; as depicted in FIG. 9B, the wires 230, 330 extend in length as electro-deposition continues; as depicted in FIG. 9C, the ends of the wires 230, 330 are polished for desirable smoothness; and as depicted in FIG. 9D, the wires 230, 330 are obtained by removing and etching the membrane 804 by the use of a base such as NaOH.

### Example 5

### Evaluating Test Specifications of the Wires

Copper nanowires are grown in an electrochemical cell with templates made of Anodic Alumina Oxide (AAO), with pore diameters of 200 nm, 150 nm and 50 nm.

Table I tabulates selected specifications of the wires grown according to the example. Some of the test specifications as referenced in Table I are defined according to the following. As depicted in FIGS. 8A-8B, a plurality of pores 806 are created within the AAO membrane 804, which is provided with an average thickness indicated as “T.” The average thickness “T” of the AAO membrane 804 as employed in this example is about 47-50 μm. A wire, generally shown at 230, 330 in FIG. 8C, is grown to its length “L” within one of the pores 806. The length “L” of the wires 410 can be adjusted by controlling the extent of its growth; however, the length “L” should be no greater than the average thickness “T” for the AAO membrane 804. As referenced in the Table I, pore density is the number of pores 806 per square centimeters (cm²) of the AAO membrane 804. In this example, the growth of the wires 230, 330 can be controlled such that the wires 230, 330 have an average length of 1 μm to 50 μm, and particularly 1 μm to 10 μm. As referenced in the Table I, peripheral area is the area shown at 812; basal area is the area shown at 814; and the total surface area represents the sum of the basal area and the peripheral area times the total number of the wires or the total number of the pores per cm², plus the void area on substrate where no wire is grown.

TABLE I
Selected Specifications of the wires Grown

| | | AAO | | |
|---|---|---|---|---|
| Pore | Pore | Membrane | | Total Surface Area |
| Density #/ | Diameter | Thickness | Wire Length | cm²/cm² growth |
| cm² | nm | μm | μm | surface |
| 2 × 10⁹ | 150 | 50 | 1.3 | 12.2 |
| 4 × 10⁹ | 73 | 47 | 1 | 9.2 |
| 5 × 10⁹ | 55 | 50 | 1 | 8.6 |
| 1 × 10¹⁰ | 35 | 49 | 1 | 11.0 |
| 1 × 10¹¹ | 13 | 50 | 1 | 40.8 |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A catalyst ink comprising:
a number of catalytic particles each including a particle base which supports a 2-dimension (2D) extensive catalyst film, the 2D extensive catalyst film including at least one precious metal.

2. The catalyst ink of claim 1, wherein the 2D extensive catalyst film contacts an exterior surface of the particle base.

3. The catalyst ink of claim 1, wherein the 2D extensive catalyst film contacts an interior surface of the particle base.

4. The catalyst ink of claim 1, wherein the particle base has a base dimension that is 50 to 10,000 times greater than a thickness of the 2D extensive catalyst film.

5. The catalyst ink of claim 1, wherein the particle base has a base dimension that is 100 to 5,000 times greater than a thickness of the 2D extensive catalyst film.

6. The catalyst ink of claim 1, wherein the 2D extensive catalyst film has a thickness of 1 to 20 atomic layers.

7. The catalyst ink of claim 1, further comprising, for at least a portion of the particles, a first intermediate coating disposed between the particle base and the 2D extensive catalyst film.

8. The catalyst ink of claim 7, further comprising a second intermediate coating disposed between the particle base and the 2D extensive catalyst film.

9. The catalyst ink of claim 8, wherein the first and the second intermediate coatings respectively include a first and a second polymer materials, the first polymer material being different from the second polymer material.

10. The catalyst ink of claim 1, wherein the particle base includes glass.

11. The catalyst ink of claim 1, wherein the particle base includes a non-precious metal.

12. The catalyst ink of claim 1, further comprising an ink filler.

13. A catalyst ink comprising:
a number of catalytic particles each including a particle base, a 2-dimension (2D) extensive catalyst film, and a first intermediate coating disposed between the particle base and the 2D extensive catalyst film, the 2D extensive catalyst film including at least one precious metal, the particle base having a base dimension that is 50 to 10,000 times greater than a thickness of the 2D extensive catalyst film.

14. The catalyst ink of claim 13, further comprising a second intermediate coating disposed between the particle base and the 2D extensive catalyst film, wherein the first and the second intermediate coatings respectively include a first and a second polymer materials, the first polymer material being different from the second polymer material.

15. The catalyst ink of claim 13, wherein the 2D extensive catalyst film has a thickness of 1 to 20 atomic layers.

16. The catalyst ink of claim 13, wherein the 2D extensive catalyst film contacts a portion of the particle base, the portion being selected from the group consisting of an interior surface, an exterior surface, and combinations thereof.

17. The catalyst ink of claim 13, wherein the particle base has a base dimension that is 100 to 5,000 times greater than a thickness of the 2D extensive catalyst film.

18. The catalyst ink of claim 13, wherein the particle base includes glass.

19. The catalyst ink of claim 13, further comprising an ink filler.

20. A catalyst ink comprising:
a number of catalytic particles each including a particle base, a 2-dimension (2D) extensive catalyst film, and an intermediate coating disposed between the particle base and the 2D extensive catalyst film, the 2D extensive catalyst film including at least one precious metal, the particle base having a base dimension that is 50 to 1,000 times greater than a thickness of the 2D extensive catalyst film, the particle base including glass.
